(19) United States
(12) Patent Application Publication
(10) Pub. No.: US 2023/0081930 A1
(43) Pub. Date: Mar. 16, 2023

(54) DATA COLLECTION DEVICE, DATA COLLECTION METHOD, AND DATA COLLECTION PROGRAM

(71) Applicant: TOYOTA JIDOSHA KABUSHIKI KAISHA, Toyota-shi Aichi-ken (JP)

(72) Inventors: Daiki Yokoyama, Gotemba-shi Shizuoka-ken (JP); Akihito Ito, Inazawa-shi Aichi-ken (JP); Ryo Nakabayashi, Susono-shi Shizuoka-ken (JP); Tatsuya Imamura, Okazaki-shi Aichi-ken (JP); Tomohiro Kaneko, Mishima-shi Shizuoka-ken (JP); Hiroki Murata, Gotemba-shi Shizuoka-ken (JP)

(73) Assignee: TOYOTA JIDOSHA KABUSHIKI KAISHA, Toyota-shi Aichi-ken (JP)

(21) Appl. No.: 17/941,604

(22) Filed: Sep. 9, 2022

(30) Foreign Application Priority Data
Sep. 14, 2021 (JP) 2021-149678

(51) Int. Cl. G06T 7/70; G06T 7/20; G06V 10/70; G06V 20/52; G06V 40/10

(52) U.S. Cl. CPC G06T 7/70; G06T 7/20; G06V 10/70; G06V 20/52; G06V 40/103; G06V 2201/07; G06T 2207/30242

(57) ABSTRACT

A data collection apparatus collects data used for a process, based on image data representing a group of consecutive images received from an imaging device. A processor of the data collection apparatus is configured to: control transmission of image data to the data collection apparatus; detect an object included in each image of an image group represented by the image data; track a detected object between consecutive images; store object image data relating to each object tracked; and calculate a number of objects included in an image represented by the image data. The control of transmission of the image data or the detection of the objects is performed such that an amount of data per unit number of objects is smaller when the calculated number of objects is relatively larger, as compared to when the number is relatively smaller.

### CROSS-REFERENCE TO RELATED APPLICATIONS

This application claims priority to Japanese Patent Application No. 2021-149678 filed on Sep. 14, 2021, which is incorporated herein by reference in its entirety.

### TECHNICAL FIELD

The present disclosure relates to a data collection apparatus, a data collection method, and a data collection program.

### BACKGROUND

In smart cities, it has been proposed to collect data from multiple entities within the community. In particular, in JP2013-069084 A1, since there is uncertainty in data obtained from information systems of different business entities, it has been proposed to collect data after correcting the obtained data in order to solve the uncertainty.

Incidentally, in a smart city or the like, various processes may be performed on the basis of image data acquired from a plurality of cameras or the like provided in the smart city or the like. In performing such processing, it is necessary to receive image data from a plurality of cameras, modify the received image data so that it can be easily used for the processing, and collect the modified data for the processing.

Specifically, for example, it is conceivable to detect an object in each of the image data in a group of consecutive images, to track the detected object between consecutive images, and to collect consecutive image data for each object tracked in this manner. Then, it is conceivable to input the consecutive image data regarding each object collected in this manner to a machine learning model, and output the evaluation of each object from the machine learning model.

Here, tracking between consecutive images of a detected object is performed for each detected object. Thus, if too many objects are detected in each image data, the processing load required for tracking in the processor is large.

In view of the above problems, an object of the present disclosure is to suppress a processing load of a processor even when the number of objects detected in image data is large.

### SUMMARY

(1) A data collection apparatus for collecting data used for a predetermined process, based on image data representing a group of consecutive images received from an imaging device, the data collection apparatus comprising a processor, configured to:

control transmission of image data from the imaging device to the data collection apparatus;

detect an object included in each image of an image group represented by the image data received from the imaging device;

track a detected object between consecutive images;

store object image data relating to each object tracked, as data used for the process, in a storage device; and

calculate a number of objects included in an image represented by the image data received from the imaging device, wherein

the control of transmission of the image data or the detection of the objects is performed such that an amount of data per unit number of objects of data stored in a storage device is smaller in a case where the calculated number of objects is relatively larger, as compared to a case where the calculated number of objects is relatively smaller.
(2) The data collection apparatus according to above (1), wherein when the calculated number of objects is relatively larger, the processor causes a frequency of transmission of the image from the imaging device to the data collection apparatus to be lower than when the calculated number of objects is relatively smaller.
(3) The data collection apparatus according to above (1) or (2), wherein when the calculated number of objects is relatively larger, the processor decreases a detection frequency of the objects, compared with a case where the calculated number of objects is relatively smaller.
(4) The data collection apparatus according to any one of above (1) to (3), wherein the processor controls the transmission or detects the object such that the larger the calculated number of objects, the smaller the amount of data per unit number of objects of data stored in the storage device.
(5) The data collection apparatus according to any one of above (1) to (4), wherein processor calculates the number of the detected objects.
(6) The data collection apparatus according to any one of above (1) to (5), wherein the predetermined process is a process for inputting object image data relating to each object stored in the storage device to a machine learning model for outputting a value of an output parameter related to the image data when the image data is inputted, and outputting a value of the output parameter.
(7) A data collection method for collecting data used for a predetermined process, on the basis of image data representing a group of consecutive images received from an imaging device, the data collection method comprising:

controlling transmission of image data from the imaging device;

detecting objects included in respective images of a group of images represented by the image data received from the imaging device;

tracking detected objects between consecutive images;

storing object image data relating to the tracked objects, as data used for the process, in a storage device; and

calculating a number of objects included in an image represented by the image data received from the imaging device, wherein

the control of transmission of the image data or the detection of the objects is performed such that when the calculated number of objects is relatively larger, an amount of data per unit number of objects of data stored in the storage device is smaller, compared to when the calculated number of objects is relatively smaller.
(8) A non-transitory recording medium having recorded thereon a data collection program for collecting data used for a predetermined process, based on image data representing a group of consecutive images received from an imaging apparatus, the data collection program causing a computer to:

control transmission of image data from the imaging device;

detect objects included in respective images of the group of images represented by the image data received from the imaging device;

track detected objects between consecutive images;

cause object image data relating to the tracked objects to be stored in a storage device as data used for the process; and

calculate a number of objects included in an image represented by the image data received from the imaging device, wherein

the control of transmission of the image data or the detection of the objects is performed such that when the calculated number of objects is relatively larger, compared to when the number of the calculated objects is relatively smaller, an amount of data per unit number of objects of data stored in the storage device is smaller.

### BRIEF DESCRIPTION OF THE DRAWINGS

FIG. 1 is a schematic configuration diagram of a machine learning system according to one embodiment.

FIG. 2 is a diagram schematically showing a hardware configuration of a server.

FIG. 3 is a functional block diagram of a processor of a server.

FIG. 4 is a flowchart illustrating a flow of notification processing of a suspicious person using a machine learning model, performed on a processor of a server.

FIG. 5 is a flowchart illustrating a flow of training processing of a machine learning model performed on a processor of a server.

FIG. 6 is a flowchart illustrating a flow of image data collection processing performed in a processor of a server.

FIG. 7 is a diagram showing the relationship between the number of persons and the target transmission frequency of image data.

FIG. 8 is a functional block diagram of a processor of a server according to the second embodiment.

FIG. 9 is a flowchart illustrating a flow of image data collection processing performed in a processor of a server according to the second embodiment.

FIG. 10 is a diagram showing the relationship between the number of persons and the target detection frequency.

### DESCRIPTION OF EMBODIMENTS

Hereinafter, embodiments will be described in detail with reference to the drawings. In the following description, similar components are denoted by the same reference numerals.

### First Embodiment

### Configuration of the Machine Learning System

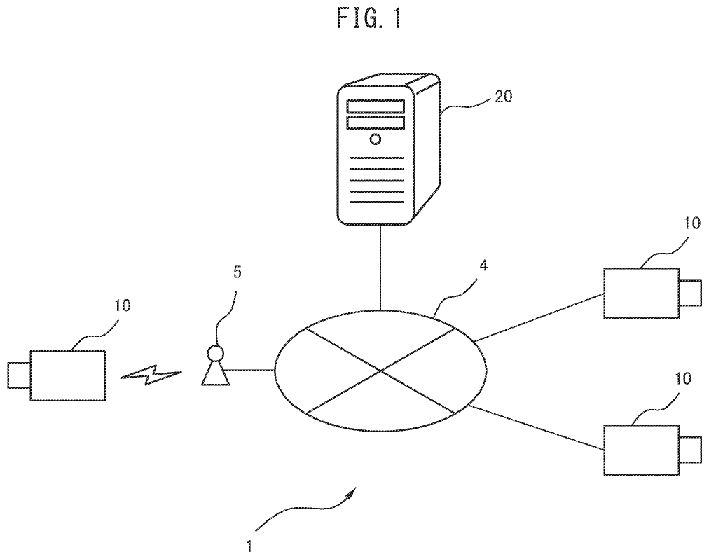

The configuration of a machine learning system 1 according to the first embodiment will be described with reference to FIGS. 1 to 7. FIG. 1 is a schematic configuration diagram of the machine learning system 1 according to one embodiment. The machine learning system 1 trains a machine learning model used in a server. The machine learning system also functions as a data collection system that collects data necessary for training the machine learning model from a plurality of imaging devices.

As shown in FIG. 1, the machine learning system 1 includes a plurality of imaging devices 10 and a server 20 capable of communicating with the imaging devices 10. Each of the plurality of imaging devices 10 and the server 20 is configured to be able to communicate with each other via a communication network 4 and, as necessary, a wireless base station 5. The communication network 4 is composed of, for example, an optical communication line, and includes an Internet network, a carrier network, and the like. The wireless base station 5 is connected to the communication network 4 via a gateway (not shown). As the communication between the imaging devices 10 and the wireless base station 5, various wide-area wireless communication with long communication distances can be used, and, for example, communication conforming to any communication standard such as 4G, LTE, 5G, WiMAX, etc. formulated by 3GPP, IEEE is used.

In particular, in the present embodiment, the server 20 communicates with the imaging devices 10 located within a predetermined target area. The target area is a range surrounded by predetermined boundaries. For example, it may be a smart city defined as “a sustainable city or region that continues to solve various problems faced by cities and regions and create new value, through the sophistication of management (planning, maintenance, management, operation, etc.), while utilizing new technologies such as ICT.”

Each imaging device 10 is installed at a predetermined position in the predetermined target area, and generates image data representing a group of consecutive images by capturing the periphery of the imaging device 10. Each imaging device 10 may be, for example, a surveillance camera disposed in a target area. Note that the imaging device 10 may be any camera as long as it can capture an arbitrary region within the target area. Therefore, the imaging device 10 may be a camera disposed in a vehicle located in the target area, or a terminal device with a camera located in the target area (a terminal held by an individual, such as eyeglasses-type terminal, etc.)

Each imaging device 10 includes a communication module directly connected to the communication network 4, and image data generated by the imaging device 10 is transmitted from the imaging device 10 to the server 20 via the communication network. Alternatively, the imaging device 10 may include a communication module capable of communicating with the wireless base stations 5. In this case, the image data generated by the imaging device 10 is transmitted from the imaging device 10 to the server 20 via the wireless base station 5 and the communication network 4.

The server 20 is connected to a plurality of imaging devices 10 via the communication network 4. The server 20 performs processing using a machine learning model, which will be described later, based on the image data generated by the plurality of imaging devices 10. In addition, the server 20 also functions as a training device for training the machine learning model used in the server 20. The server 20 also functions as a data collection device that collects data used for the use and training of the machine learning model based on the consecutive image data received from the plurality of imaging devices 10.

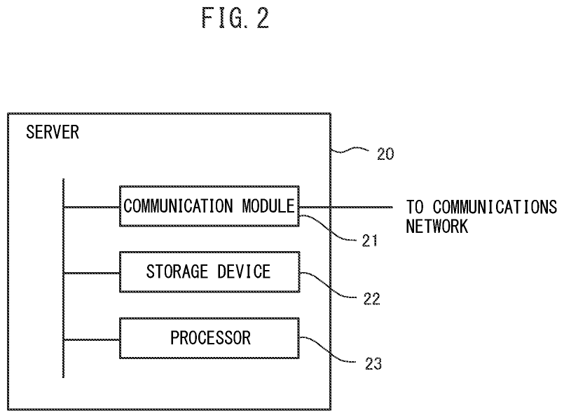

FIG. 2 is a diagram schematically showing a hardware configuration of the server 20. The server 20 includes a communication module 21, a storage device 22, and a processor 23, as illustrated in FIG. 2. The server 20 may include input devices such as a keyboard and a mouse, and output devices such as a display and a speaker.

The communication module 21 is an example of a communication device for communicating with devices outside the server 20. The communication module 21 comprises an interface circuit for connecting the server 20 to the communication network 4. The communication module 21 is configured to be able to communicate with each of the plurality of imaging devices 10 via the communication network 4 and the wireless base station 5.

The storage device 22 is an example of a storage/memory device for storing data. The storage device 22 includes, for example, a hard disk drive (HDD), a solid state drive (SSD), or an optical recording medium. The storage device 22 may include a volatile semiconductor memory (e.g., RAM), a nonvolatile semiconductor memory (e.g., ROM), or the like. The storage device 22 stores a computer program for executing various processing by the processor 23 and various data used when various processing is executed by the processor 23. In particular, the storage device 22 stores image data received from the imaging device 10, and data used for processing by the machine learning model and training of the machine learning model.

The processor 23 has one or a plurality of CPUs and peripheral circuits thereof. The processor 23 may further comprise a GPU, or an arithmetic circuit such as a logical or numerical unit. The processor 23 executes various kinds of processing based on a computer program stored in the storage device 22. Specific processing executed by the processor 23 of the server 20 will be described later.

### Machine Learning Model

In the present embodiment, a machine learning model subjected to machine learning is used when arbitrary processing is performed in the server 20. The machine learning model is a model based on various machine learning algorithms. In the present embodiment, the machine learning model is a model learned by supervised learning, such as a neural network (NN), a support vector machine (SVM), or a decision tree (DT).

In the present embodiment, the machine learning model receives as input parameters, image data representing a group of consecutive images relating to the same object (in particular, a person) included in images represented by image data representing a group of consecutive images. Then, the machine learning model outputs, as an output parameter, a characteristic relating to the object to which image data representing a group of consecutive images is input in this manner. Specifically, the machine learning model is a model in which, when image data representing a group of consecutive images relating to the same person is input, the suspiciousness degree of the person (the degree of possibility that the person will perform an abnormal action such as a crime in the future) is calculated.

Note that the machine learning model may be any model as long as it is a model in which, when image data representing a group of consecutive images relating to the same person is input, characteristics relating to the person are output. Therefore, for example, the machine learning model may be a model in which, when image data representing a group of consecutive images relating to the same person is input, the degree of the physical condition of the person (e.g., the degree of the physical condition of the person being bad) is calculated.

Specifically, in the present embodiment, for example, a recurrent neural network (RNN) model is used as the machine learning model. In particular, in the present embodiment, LSTM (Long Short-Term Memory) networks are used as the machine learning models among the RNN models. The RNN model outputs the suspiciousness degree of the same person when time-series consecutive image data of the same person is input.

The machine learning model is trained using a training data set that includes data used as input parameters and values of output parameters (ground truth values or ground truth labels) corresponding to the data. In the present embodiment, the training data set includes image data representing a group of consecutive images relating to the same person, and ground truth values corresponding to the image data (e.g., 1 when an abnormal action such as a crime is actually performed, and 0 when such an action is not performed).

In machine learning of the RNN model, model parameters (e.g., weights and biases) in the RNN model are repeatedly updated, for example, by a known error back-propagation method so that the difference between the output value of the RNN model and the ground truth value of the output parameter included in the training data set is reduced. As a result, the RNN model is trained, and a trained RNN model is generated. For the machine learning in the machine learning model, any known technique can be used. In this specification, the model parameter means a parameter whose value is repeatedly updated by training.

### Use of Machine Learning Models

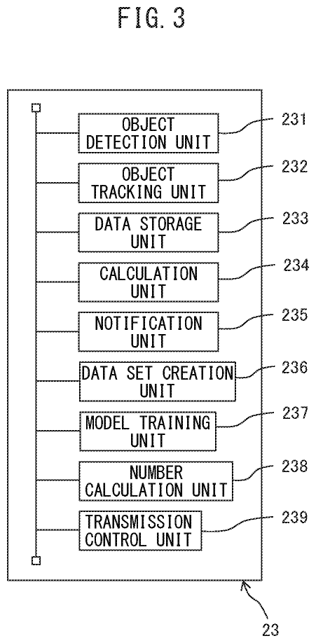

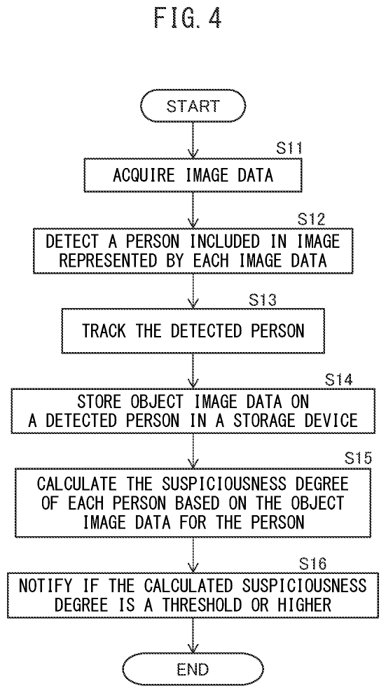

Next, processing using the machine learning model in the server 20 will be described with reference to FIGS. 3 and 4. In the present embodiment, the server 20 calculates the suspiciousness degree of the person in the image represented by the image data, based on the image data created by the imaging device 10. In addition, the server 20 notifies the user who uses the server of a person with a high suspiciousness degree, when the suspiciousness degree reaches or exceeds a predetermined reference value.

FIG. 3 is a functional block diagram of the processor 23 of the server 20. As shown in FIG. 3, the processor 23 includes an object detection unit 231, an object tracking unit 232, a data storage unit 233, a calculation unit 234, a notification unit 235, a data set creation unit 236, a model training unit 237, a number calculation unit 238, and a transmission control unit 239. These functional blocks of the processor 23 of the server 20 are, for example, functional modules implemented by computer programs running on the processor 23. Alternatively, the functional blocks included in the processor 23 may be dedicated arithmetic circuits provided in the processor 23. In particular, for notifying the suspicious person to the user by calculating the suspiciousness degree, the object detection unit 231, the object tracking unit 232, the data storage unit 233, the calculation unit 234, and the notification unit 235 are used.

The object detection unit 231 detects an object included in each image of the group of images represented by the image data received from the imaging device 10. In particular, in the present embodiment, the object detection unit 231 detects a person included in each image of the group of images represented by the image data received from the imaging device 10.

The detection of a person included in each image of the group of images represented by the image data is performed by any known object recognition technique. For example, when image data representing one image is input, the object detection unit 231 detects a person by using an object detection model (e.g., an NN model) that outputs a person included in an image represented by the image data and coordinates in the image of the person. In this case, the object detection unit 231 extracts image data representing each image from the image data representing the group of consecutive images received from the imaging device 10. Then, the object detection unit 231 inputs image data representing each image to the NN model, and detects a person included in the image. As the NN model for detecting such a person, for example, a model using any known object detecting algorithm such as a convolutional neural network (CNN) model such as faster-RCNN, YOLO, SSD is used.

The object tracking unit 232 tracks the detected object (in particular, a person) between consecutive images. That is, the object tracking unit 232 associates the person detected in each image included in the image data received from the imaging device 10 with the person detected in the immediately preceding image. When a plurality of persons are detected in the first image of two consecutive images, the object tracking unit 232 associates each person with the corresponding person detected in the immediately preceding second image. When the person corresponding to the person detected in the first image among the two consecutive images is not detected in the immediately preceding second image, the object tracking unit 232 treats the person as having appeared for the first time in the first image. Similarly, when a person corresponding to a person detected in the first image among two consecutive images is not detected in the immediately following second image, the object tracking unit 232 treats the person as a person who disappears from the image after appearing in the first image.

The tracking in the object tracking unit 232 is performed by any known tracking method. Specifically, as the tracking method, for example, a method using an optical flow such as a Lucas-Kanade method or a Horn-Schunk method is used.

The data storage unit 233 stores the object image data relating to each object tracked by the object tracking unit 232 (in particular, each person) in the storage device 22. Specifically, in the present embodiment, the data storage unit 233 extracts an image of each person tracked by the object tracking unit 232 from each image in which the person is detected. The data storage unit 233 stores a plurality of consecutive images of each person extracted in this manner, as object image data, in the storage device 22. Therefore, when a plurality of persons are tracked by the object tracking unit 232, an amount of object image data equal to the number of persons tracked is stored in the storage device 22. The object image data relating to each person stored in the storage device 22 in this manner is used for calculating the suspiciousness degree using the machine learning model, and is also used for training the machine learning model.

The calculation unit 234 calculates the suspiciousness degree of the object (in particular, the person) by using the machine learning model, based on the object image data relating to each person stored in the storage device 22. The machine learning model is, for example, an RNN model in which, when object image data representing a group of consecutive images relating to each person is input as an input parameter, the suspiciousness degree of the person is output as an output parameter. Therefore, the calculation unit 234 inputs the object image data relating to each person as an input parameter to the machine learning model, and outputs the suspiciousness degree, which is an output parameter output from the machine learning model.

When there is a person whose suspiciousness degree calculated by the calculation unit 234 is equal to or higher than a predetermined threshold value, the notification unit 235 notifies the user or another processing device (not shown) that there is a suspicious person. At this time, the notification unit 235 may also output other information about the suspicious person, such as the image of the suspicious person and the current position of the suspicious person. The notification to the user is performed, for example, by an output device such as a display or a speaker provided in the server 20. The other processing device includes, for example, a device for collecting suspicious person information or the like, in an administrative organization such as a police or a security company. The other processing device is connected to the server 20, for example, via the communication network 4. Accordingly, the notification to the other processing device is performed via the communication network 4.

In the present embodiment, the calculation unit 234 calculates the suspiciousness degree of each person using the machine learning model, based on the object image data of each person. However, the calculation unit 234 may calculate the value of another parameter for the person using the machine learning model. In this case, the notification unit 235 notifies the user or another processing device, based on the value of the parameter calculated by the calculation unit 234.

More specifically, for example, the calculation unit 234 may calculate the degree of bad physical condition for each person, using a machine learning model, based on object image data representing a group of consecutive images relating to each person. In this case, the notification unit 235 notifies the user or another processing device that there is a person whose physical condition is bad, when there is a person whose bad physical condition degree is equal to or higher than a predetermined threshold value set in advance. In addition, the notification unit 235 may also output other information about the person in the bad physical condition, such as the image of the person in the bad physical condition and the current position of the person.

In any case, the machine learning model may be any model as long as the machine learning model is a model in which, when object image data relating to each person (or each object) is input as an input parameter, a value of an output parameter relating to the object image data is output. Then, the calculation unit 234 inputs the object image data relating to each person to the machine learning model, and outputs the value of the output parameter output from the machine learning model.

FIG. 4 is a flowchart showing a flow of a suspicious person notification process using a machine learning model, which is performed in the processor 23 of the server 20.

As shown in FIG. 4, the processor 23 of the server 20 acquires image data representing a group of consecutive images received from the imaging device 10 via the communication network 4 (Step S11). Specifically, the imaging device 10 transmits the generated image data to the server 20 every time the image data representing the image taken around the imaging device 10 is generated. Therefore, the imaging device 10 continuously transmits image data representing an image taken around the imaging device 10. Upon receipt of such image data, the processor 23 causes the storage device 22 of the server 20 to store the received image data. Therefore, the storage device 22 stores the image data representing the group of consecutive images received from the imaging device 10. Then, the object detection unit 231 of the processor 23 acquires the image data stored in the storage device 22 from the storage device 22 (the image data representing the group of consecutive images received from the imaging device 10).

When the image data is acquired, the object detection unit 231 detects a person included in each image of the image groups represented by the acquired image data (Step S12). Specifically, the object detection unit 231 inputs data representing each image of the image data acquired in step S11 to the object detection model. As a result, the person included in each image and the coordinates of the person in the image are output from the object detection model.

When a person is detected by the object detection unit 231, the object tracking unit 232 tracks each person detected by the object detection unit 231 in step S12 between consecutive images (Step S13). As a result of the tracking, the object tracking unit 232 assigns the same label to the same person in different images.

When the tracking is performed by the object tracking unit 232, the data storage unit 233 stores the object image data relating to each tracked person in the storage device 22 (Step S14). Specifically, the data storage unit 233 cuts out an image of a person to which the same label is attached by the object tracking unit 232, generates object image data representing a group of consecutive images relating to the person, and stores the generated object image data in the storage device 22. The size of the image of the cut-out person differs depending on the distance from the imaging device 10 to the person. Therefore, the image size of each image of a person differs between images or between persons. The data storage unit 233 may resize each image of the person so that the image sizes of the images of the different persons become the same for each image and for each person. Thus, in this case, all images included in the object image data for all persons have the same image size.

When the object image data relating to the person is stored in the storage device 22 by the data storage unit 233, the calculation unit 234 calculates the suspiciousness degree of the person, based on the stored object image data (Step S15). Specifically, the calculation unit 234 inputs object image data relating to each person (image data representing a group of consecutive images of each person) to the RNN model for calculating the suspiciousness degree. In particular, the calculation unit 234 sequentially inputs the data of the image group relating to each person included in the object image data to the RNN model along the time series. As a result, the suspiciousness degree of the person is output from the RNN model. The calculation unit 234 repeatedly executes the same operation for all persons stored in the storage device 22.

The notification unit 235 notifies the user or other processing device that there is a suspicious person, an image of the suspicious person, and the current position of the suspicious person, when there is a person whose suspiciousness degree calculated in step S15 is greater than a predetermined threshold value (step S16). The current position of the suspicious person is specified based on, for example, the position of the imaging device 10 where the person was last detected, the position of the person in the image created by the imaging device 10, and the like.

### Training of Machine Learning Models

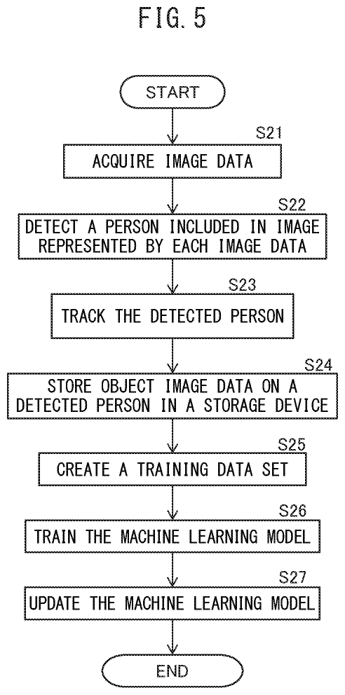

Next, the training process of the machine learning model in the server 20 will be described with reference to FIGS. 3 and 5. In the present embodiment, the server 20 performs training of a machine learning model for calculating the suspiciousness degree, based on the image data created by the imaging device 10. In training the machine learning model, the data set creation unit 236 and the model training unit 237 are used in addition to the object detection unit 231, the object tracking unit 232, and the data storage unit 233, as shown in FIG. 3.

The data set creation unit 236 creates a training data set used for training the machine learning model. As described above, the training data set includes image data representing consecutive groups of images for the same person and ground truth values corresponding to the image data.

Image data representing a group of consecutive images related to each person is stored as object image data in the storage device 22 by the data storage unit 233. Therefore, the data set creation unit 236 acquires the object image data from the storage device 22.

In addition, the data set creation unit 236 acquires information of a person who has performed an abnormal action such as a crime, for example, from a terminal device installed in an administrative organization such as a police or a security company. Alternatively, the data set creation unit 236 acquires information of a person who has performed an abnormal action from a mobile terminal device, e.g., a mobile terminal, located within the target area. The information of the person who has performed the abnormal action includes, for example, an image of the person who has performed the abnormal action, and information on the time and the position of the person who has performed the abnormal action. The data set creation unit 236 specifies the object image data of the person who has taken an abnormal action, based on the information of the person who has performed an abnormal action acquired from the terminal device and the object image data of many persons stored in the storage device 22. The object image data is specified, for example, by comparing the location and the time that each image included in the object image data was captured with the location and the time at which the abnormal action was performed, and by comparing the image of the person included in the object image data with the image of the person performing the abnormal action. When the object image data related to a person who has taken an abnormal action is specified in this way, a data set is created by setting the ground truth value of the suspicious degree corresponding to the object image data to 1. On the other hand, for a person whose information that has performed an abnormal action is not acquired from the terminal device even after a predetermined time has elapsed, a data set is created with the ground truth value of the suspicious degree corresponding to the person's object image data set to 0.

The model training unit 237 performs training of the machine learning model based on the data set created by the data set creation unit 236. Specifically, as described above, the model training unit 237 updates the model parameters used in the machine learning model, using a known error back propagation method or the like.

FIG. 5 is a flowchart showing the flow of the training process of the machine learning model performed in the processor 23 of the server 20. In the training process, as in the process shown in FIG. 4, the object image data is stored in the storage device 22. In particular, in the present embodiment, the object image data stored in the storage device 22 when the notification process shown in FIG. 4 is executed, can be used for the training process shown in FIG. 5. In any case, since steps S21 to S24 are the same as steps S11 to S14, the description thereof is omitted.

After the object image data related to the person is stored in the storage device 22 by the data storage unit 233 in step S24, the data set creation unit 236 creates a training data set (Step S25). When information of a person who has performed an abnormal action in a terminal device of an administrative organization or a mobile terminal device located in a target area is input, the data set creation unit 236 creates a data set by combining object image data of the person and 1 of a ground truth value. In addition, for a person to which information on an abnormal action has not been input from the terminal device even after a predetermined period of time has elapsed, the object image data of the person and the ground truth value 0 are combined to create a data set.

When a certain number of data sets are created by the data set creation unit 236 in step S25, the model training unit 237 uses the created data set to train the machine learning model (Step S26). The model training unit 237 updates the values of the model parameters of the machine learning model used in step S15 of FIG. 4, using the model parameters of the trained machine learning model (Step S27). After the values of the model parameters of the machine learning model are updated, the suspiciousness degree is calculated in step S15 by the machine learning model using the updated model parameters.

### Data Collection

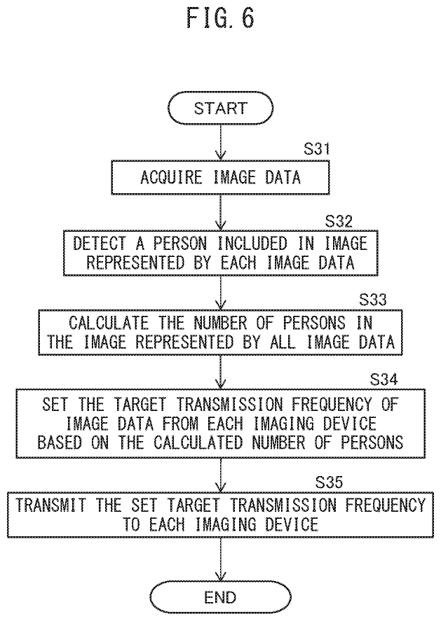

Next, a process of collecting image data in the server 20 will be described with reference to FIGS. 3 and 6. When collecting the image data, in addition to the object detection unit 231, the number calculation unit 238 and the transmission control unit 239 are used (see FIG. 3).

Incidentally, as described above, in order to calculate the suspiciousness degree of each person using the machine learning model or to train the machine learning model, object image data for each person is required. In order to create the object image data, as described above, it is desirable to detect a person included in an image represented by the image data transmitted from the imaging device 10, and to track the detected person between images.

Tracking between images is performed for each detected person. Therefore, as the number of persons in each image included in the image data transmitted from the imaging device 10 increases, the number of times of tracking increases, and therefore, the processing load applied to the processor 23 of the server 20 increases. If the processing load applied to the processor 23 is too large, the operation speed of the processor 23 is lowered and the power consumption is increased.

Therefore, in the present embodiment, when the number of persons included in the image represented by the image data generated by the imaging device 10 is large, the transmission frequency of the image data from the imaging device 10 is reduced.

The number calculation unit 238 calculates the number of persons included in the image represented by the image data received from the imaging device 10. In the present embodiment, the number calculation unit 238 calculates the number of persons detected by the object detection unit 231. Specifically, at a certain time, the number calculation unit 238 counts the number of persons included in each of the images captured by all the imaging devices 10 that transmit the image data to the server 20. Then, the number of persons obtained for each image is summed over all the images. Thereby, the number of persons included in all the images captured by all the imaging devices 10 at a certain time is calculated.

The number calculation unit 238 does not necessarily accurately calculate the number of persons included in the image represented by the image data received from all the imaging devices 10. For example, the number of all persons included in the image represented by the image data received from a part of the imaging devices 10 may be calculated (estimated). This is because the larger the number of persons included in a part of the image, the larger the number of persons included in the entire image, and there is a certain correlation between them. The number calculation unit 238 may calculate (estimate) the number of persons included in the image represented by the image data received from the imaging device 10, based on, for example, the number of mobile terminals located in the target area, instead of based on the image data generated by the imaging device 10. This is because if the number of mobile terminals located in the target area is large, the number of persons included in the entire image is large, and there is a certain correlation between them.

The transmission control unit 239 controls transmission of image data from the imaging device 10 to the server 20. The transmission control unit 239, for example, controls the transmission frequency of the image data from each imaging device 10. In other words, the transmission control unit 239 controls the ratio of the image to be transmitted to the server 20 among the images captured by the imaging device 10. Therefore, when the transmission frequency of the image data is controlled to be high, the image data including all the images generated by the imaging device 10 is transmitted to the server 20. On the other hand, when the transmission frequency of the image data is controlled to be low, the image data including a part of the images generated by the imaging device 10 is transmitted to the server 20. To control the transmission frequency of the image data from each imaging device 10, the transmission control unit 239 transmits a command relating to the transmission frequency of the image data, for example, to each imaging device 10,.

The transmission control unit 239 may control the transmission speed of the image data from the imaging device 10 to the server 20. In this case, for example, the transmission control unit 239 transmits a command relating to the upper limit transmission speed of the image data to the server 20, to each of the imaging devices 10. In any case, the transmission control unit 239 controls the data amount of the image data transmitted from the imaging device 10 to the server 20 per unit time.

FIG. 6 is a flowchart illustrating a flow of image data collection processing performed in the processor 23 of the server 20. Also in the collection processing, similarly to the processing shown in FIG. 4, detection of a person included in an image represented by image data is performed. In particular, in the present embodiment, the result of object detection performed when the notification process shown in FIG. 4 is executed, can be used for the collection process shown in FIG. 6. In any case, since steps S31 and S32 are the same as steps S11 and S12, the description thereof is omitted.

When a person included in the image is detected in step S32, the number calculation unit 238 calculates the number of persons detected by the object detection unit 231 (Step S33). In particular, the number calculation unit 238 calculates the number of persons at the time when the object detection is completed for the images created by all the imaging devices 10 at a certain time by the object detection unit 231.

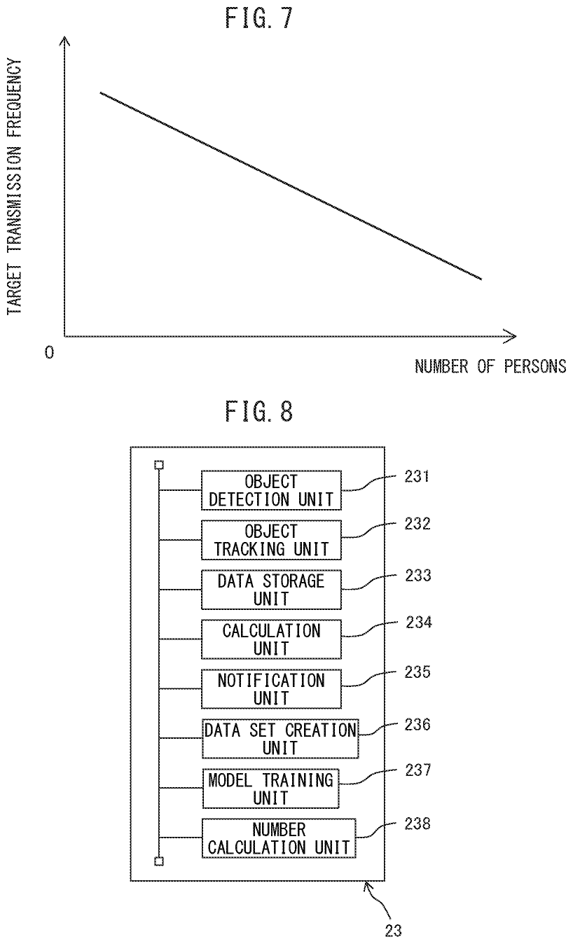

When the number of persons is calculated in step S33, the transmission control unit 239 sets the target transmission frequency of the image data from each imaging device 10, based on the calculated number of persons (step S34). FIG. 7 is a diagram showing the relationship between the number of persons calculated in step S33 and the target transmission frequency of image data from each imaging device 10 to the server 20. As shown in FIG. 7, in the present embodiment, the transmission control unit 239 sets the target transmission frequency so that the target transmission frequency of the image data becomes lower as the number of persons included in the image increases.

When the target transmission frequency decreases, the transmission frequency of the image data from each imaging device 10 to the server 20 decreases, so that the number of images included in the image data received by the server 20 per unit time decreases. As the number of images included in the image data received by the server 20 decreases, the frequency of object detection by the object detection unit 231 decreases, and the frequency of tracking by the object tracking unit 232 decreases. Finally, the amount of data per unit object amount of data stored in the storage device 22 by the data storage unit decreases. In other words, in the present embodiment, the transmission control unit 239 controls the transmission of the image data from each imaging device 10 so that the data amount per unit object amount becomes smaller, as the number of persons included in the image calculated in step S33 increases.

When the target transmission frequency of the image data from each imaging device 10 is set in step S34, the transmission control unit 239 transmits a command relating to the target transmission frequency to each imaging device 10 (step S35).

### Effects and Modifications

In the present embodiment, as the number of persons included in the image represented by the image data received from the imaging device 10 increases, the target transmission frequency of the image data from the imaging device 10 to the server 20 decreases. As a result, as the number of persons included in the image increases, the frequency of tracking performed on one person by the object tracking unit 232 decreases. Therefore, it is possible to suppress the processing load required for tracking to a low level, thereby suppressing a decrease in the operation speed of the processor 23 and an increase in the power consumption.

In the above embodiment, as shown in FIG. 7, the target transmission frequency is continuously set in accordance with the number of persons so that the target transmission frequency of the image data from the imaging device 10 to the server 20 becomes lower as the number of persons included in the image increases. However, the target transmission frequency may be set stepwise in accordance with the number of persons so that the target transmission frequency of the image data from the imaging device 10 to the server 20 becomes lower as the number of persons included in the image increases. Therefore, for example, when the number of persons included in the image is less than the predetermined number, the target transmission frequency may be set to the first frequency, and when the number of persons included in the image is equal to or greater than the predetermined number, the target transmission frequency may be set to the second frequency which is less than the first frequency. In any case, when the number of persons calculated by the number calculation unit 238 is relatively large, the transmission control unit 239 causes the frequency of image transmission from the imaging device 10 to the server 20 to be lower than when the number of persons calculated by the number calculation unit 238 is relatively small. In other words, in the present embodiment, when the number of persons calculated by the number calculation unit 238 is relatively large, the transmission control unit 239 controls the transmission of the image data from each imaging device 10 so that the amount of data per unit number of persons of the data stored in the storage device 22 by the data storage unit 233 is smaller than when the number of persons calculated by the number calculation unit 238 is relatively small.

### Second Embodiment

Next, the machine learning system 1 according to the second embodiment will be described with reference to FIGS. 8 to 10. Hereinafter, a description will be given focusing on a portions different from the machine learning system 1 according to the first embodiment.

In the first embodiment, as the number of persons included in the image represented by the image data received from the imaging device 10 increases, the target transmission frequency of the image data from the imaging device 10 to the server 20 decreases. On the other hand, in the present embodiment, as the number of persons included in the image represented by the image data received from the imaging device 10 increases, the detection frequency of the persons in the object detection unit 231 decreases.

FIG. 8 is a functional block diagram of the processor 23 of the server 20 according to the second embodiment. As shown in FIG. 8, in the second embodiment, the processor 23 does not include the transmission control unit 239. Therefore, in the present embodiment, the imaging device 10 transmits all the image data generated by the imaging device 10 to the server 20.

In the present embodiment, similarly to the first embodiment, the object detection unit 231 detects a person included in each image of the image group represented by the image data received from the imaging device 10. However, in the present embodiment, the object detection unit 231 detects a person at an arbitrary detection frequency. Therefore, the object detection unit 231 does not necessarily detect a person with all the images included in the image data received from the imaging device 10. When the target detection frequency is set high, the object detection unit 231 detects a person for all the images included in the image data received from the imaging device 10. On the other hand, when the target detection frequency is set low, the object detection unit 231 detects a person only for a part of the image included in the image data received from the imaging device 10.

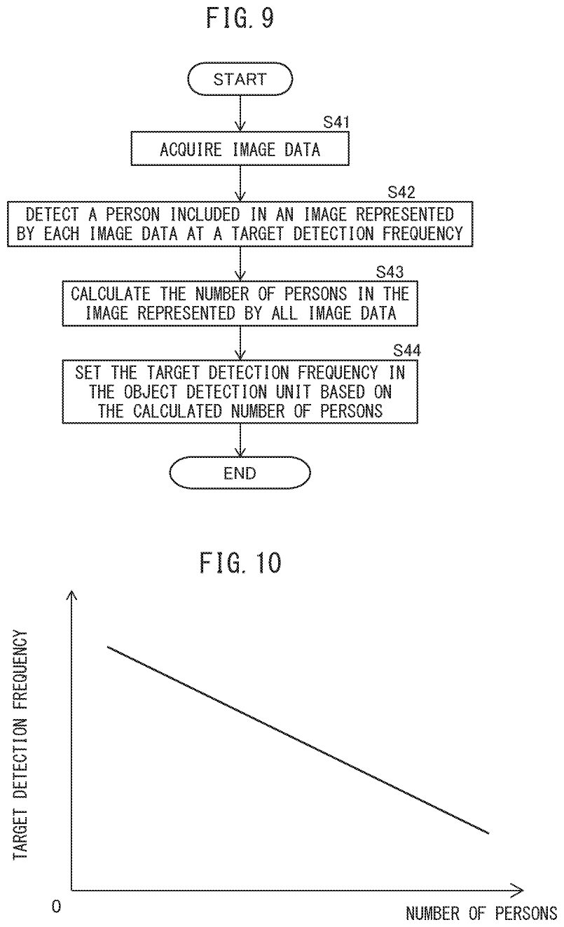

FIG. 9 is a flowchart showing a flow of image data collection processing performed in the processor 23 of the server 20 according to the second embodiment. Steps S41 and S43 in the figure are the same as steps S31 and S33 in FIG. 6, and therefore an explanation thereof is omitted.

When the processor 23 acquires the image data in step S41, the object detection unit 231 detects a person in the image included in the acquired image data (step S42). In particular, in the present embodiment, the object detection unit 231 detects a person in the image at the target detection frequency previously set in step S44, which will be described later.

Thereafter, when the number of persons is calculated in step S43, the object detection unit 231 sets the target detection frequency based on the calculated number of persons (Step S44). FIG. 10 is a diagram showing the relationship between the number of persons calculated in step S43 and the target detection frequency in the object detection unit 231. As shown in FIG. 10, in the present embodiment, the object detection unit 231 sets the target detection frequency so that the detection frequency of the person becomes lower as the number of persons included in the image increases.

When the target detection frequency decreases, the number of images in which detection of a person is performed by the object detection unit 231 decreases. Therefore, the frequency at which tracking is performed in the object tracking unit 232 decreases, and the amount of data per unit object amount of data stored in the storage device 22 by the data storage unit 233 decreases. In other words, in the present embodiment, the object detection unit 231 detects a person such that the larger the number of persons included in the image calculated in step S43, the smaller the amount of data per unit number of persons.

In the present embodiment, the larger the number of persons included in the image represented by the image data received from the imaging device 10, the lower the target detection frequency in the object detection unit 231. As a result, as the number of persons included in the image increases, the frequency of tracking performed on one person by the object tracking unit 232 decreases. Therefore, it is possible to suppress the processing load required for tracking to a low level, thereby suppressing a decrease in the operation speed of the processor 23 and an increase in the power consumption.

In the above embodiment, as shown in FIG. 10, the target detection frequency is continuously set in accordance with the number of persons so that the target detection frequency in the object detection unit 231 becomes lower as the number of persons included in the image increases. However, the target detection frequency may be set stepwise in accordance with the number of persons so that the target detection frequency in the object detection unit 231 decreases as the number of persons included in the image increases. Therefore, for example, when the number of persons included in the image is less than the predetermined number, the target detection frequency may be set to the first frequency, and when the number of persons included in the image is equal to or greater than the predetermined number, the target detection frequency may be set to the second frequency which is less than the first frequency. In any case, when the number of persons calculated by the number calculation unit 238 is relatively large, the object detection unit 231 makes the detection frequency in the object detection unit 231 lower than when the number of persons calculated by the number calculation unit 238 is relatively small. In other words, in the present embodiment, when the number of persons calculated by the number calculation unit 238 is relatively large, the object detection unit 231 detects a person so that the amount of data per unit number of persons of data stored in the storage device 22 by the data storage unit 233 is smaller than when the number of persons calculated by the number calculation unit 238 is relatively small.

Also in the present embodiment, the processor 23 may include a transmission control unit 239. In this case, transmission control by the transmission control unit 239 and detection by the object detection unit 231 are performed so that the larger the number of persons calculated by the number calculation unit 238, the smaller the amount of data per unit number of persons stored in the storage device 22.

In the above embodiment, the object detection unit 231 detects a person, and the object tracking unit 232 performs tracking of the detected person. However, the object detection unit 231 may detect an object other than a person, or the object tracking unit 232 may track an object other than a person. In this case, the machine learning model used in the calculation unit 234 is, for example, a model for calculating the suspiciousness degree of an object when image data representing an image group relating to the object other than a person is input.

While preferred embodiments of the present disclosure have been described above, the present disclosure is not limited to these embodiments, and various modifications and changes may be made within the scope of the appended claims.

1. A data collection apparatus for collecting data used for a predetermined process, based on image data representing a group of consecutive images received from an imaging device, the data collection apparatus comprising a processor, wherein
the processor is configured to:
control transmission of image data from the imaging device to the data collection apparatus;
detect an object included in each image of an image group represented by the image data received from the imaging device;
track a detected object between consecutive images;
store object image data relating to each object tracked, as data used for the process, in a storage device; and
calculate a number of objects included in an image represented by the image data received from the imaging device, wherein
the control of transmission of the image data or the detection of the objects is performed such that an amount of data per unit number of objects of data stored in the storage device is smaller in a case where the calculated number of objects is relatively larger, as compared to a case where the calculated number of objects is relatively smaller.

2. The data collection apparatus according to claim 1, wherein when the calculated number of objects is relatively larger, the processor causes a frequency of transmission of the image from the imaging device to the data collection apparatus to be lower than when the calculated number of objects is relatively smaller.

3. The data collection apparatus according to claim 1, wherein when the calculated number of objects is relatively larger, the processor decreases a detection frequency of the objects, compared with a case where the calculated number of objects is relatively smaller.

4. The data collection apparatus according to claim 1, wherein the processor controls the transmission or detects the object such that the larger the calculated number of objects, the smaller the amount of data per unit number of objects of data stored in the storage device.

5. The data collection apparatus according to claim 1, wherein the processor calculates the number of the detected objects.

6. The data collection apparatus according to claim 1, wherein the predetermined process is a process for inputting object image data relating to each object stored in the storage device to a machine learning model for outputting a value of an output parameter related to the image data when the image data is inputted, and outputting a value of the output parameter.

7. A data collection method for collecting data used for a predetermined process, on the basis of image data representing a group of consecutive images received from an imaging device, the data collection method comprising:
controlling transmission of image data from the imaging device;
detecting objects included in respective images of a group of images represented by the image data received from the imaging device;
tracking detected objects between consecutive images;
storing object image data relating to the tracked objects, as data used for the process, in a storage device; and
calculating a number of objects included in an image represented by the image data received from the imaging device, wherein
the control of transmission of the image data or the detection of the objects is performed such that when the calculated number of objects is relatively larger, an amount of data per unit number of objects of data stored in the storage device is smaller, compared to when the calculated number of objects is relatively smaller.

8. A non-transitory recording medium having recorded thereon a data collection program for collecting data used for a predetermined process, based on image data representing a group of consecutive images received from an imaging device, the data collection program causing a computer to:
control transmission of image data from the imaging device;
detect objects included in respective images of the group of images represented by the image data received from the imaging device;
track detected objects between consecutive images;
cause object image data relating to the tracked objects to be stored in a storage device as data used for the process; and
calculate a number of objects included in an image represented by the image data received from the imaging device, wherein
the control of transmission of the image data or the detection of the objects is performed such that when the calculated number of objects is relatively larger, compared to when the number of the calculated objects is relatively smaller, an amount of data per unit number of objects of data stored in the storage device is smaller.
